(19) United States
(12) Patent Application Publication
(10) Pub. No.: US 2012/0072473 A1
(43) Pub. Date: Mar. 22, 2012

(54) Information Processing Apparatus and Information Processing Method

(76) Inventor: Takuya Ootani, Oume-shi (JP)

(21) Appl. No.: 13/099,811

(22) Filed: May 3, 2011

(30) Foreign Application Priority Data
Sep. 22, 2010 (JP) 2010-212571

(51) Int. Cl. G06F 17/30

(52) U.S. Cl. 707/823; 707/E17.01

(57) ABSTRACT

According to one embodiment, there is provided an information processing apparatus, including: a discrimination module configured to determine whether writing-subject data to be written into a storage region of an information recording medium is high extensible data or low extensible data; and an allocation module configured to allocate a data alignable address in the storage region as an address for writing the data preferentially when the writing-subject data is the high extensible data rather than when the writing-subject data is the low extensible data.

### CROSS-REFERENCE TO RELATED APPLICATION(S)

This application is based upon and claims the benefit of priority from Japanese Patent Application No. 2010-212571, filed on Sep. 22, 2010, the entire contents of which are incorporated herein by reference.

### FIELD

An embodiment described herein relate generally to an information processing apparatus and an information processing method.

### BACKGROUND

Storage capacities of information recording devices, for example, memory cards such as SD cards, HDDs (Hard Disk Drives) etc. have increased recently.

With the increase in storage capacity of such an information recording device, a file system for controlling a process of reading/writing data from/into the information recording device has been regarded as important for a requirement of a high-speed data reading/writing process.

### BRIEF DESCRIPTION OF DRAWINGS

A general architecture that implements the various feature of the present invention will now be described with reference to the drawings. The drawings and the associated descriptions are provided to illustrate embodiments and not to limit the scope of the present invention.

FIG. 1 illustrates a main part of a personal computer (PC) in an embodiment and a main part of a memory card 200 to be managed by the PC.

FIG. 2 illustrates a memory space of a memory logically formatted by a FAT file system in this embodiment.

FIG. 3 illustrates FAT and file entries in this embodiment.

FIG. 4 illustrates a memory space of a memory logically formatted by a file system in this embodiment.

FIG. 5 illustrates a process of writing/reading data into/from a logically-formatted memory in this embodiment.

FIG. 6 illustrates a reading process for reading unaligned data in this embodiment.

FIG. 7 illustrates a reading process for reading aligned data in this embodiment.

FIG. 8 illustrates a writing process for writing data without alignment in this embodiment.

FIG. 9 illustrates a writing process for writing data with alignment in this embodiment.

FIG. 10 illustrates a state in a memory subjected to a data writing process in this embodiment.

FIG. 11 illustrates a characteristic writing process in this embodiment.

FIG. 12 illustrates a PC in this embodiment.

### DETAILED DESCRIPTION

In general, according to one embodiment, there is provided an information processing apparatus, including: a discrimination module configured to determine whether writing-subject data to be written into a storage region of an information recording medium is high extensible data or low extensible data; and an allocation module configured to allocate a data alignable address in the storage region as an address for writing the data preferentially when the writing-subject data is the high extensible data rather than when the writing-subject data is the low extensible data.

An embodiment will be described below in detail with reference to the drawings.

Although an example in which the invention is applied to a PC (Personal Computer) will be described in this embodiment, the invention may be applied also to a file system-including apparatus such as a digital television broadcast receiving apparatus or an optical disk recorder as long as the apparatus includes a file system for managing data recorded on an information recording medium to be managed.

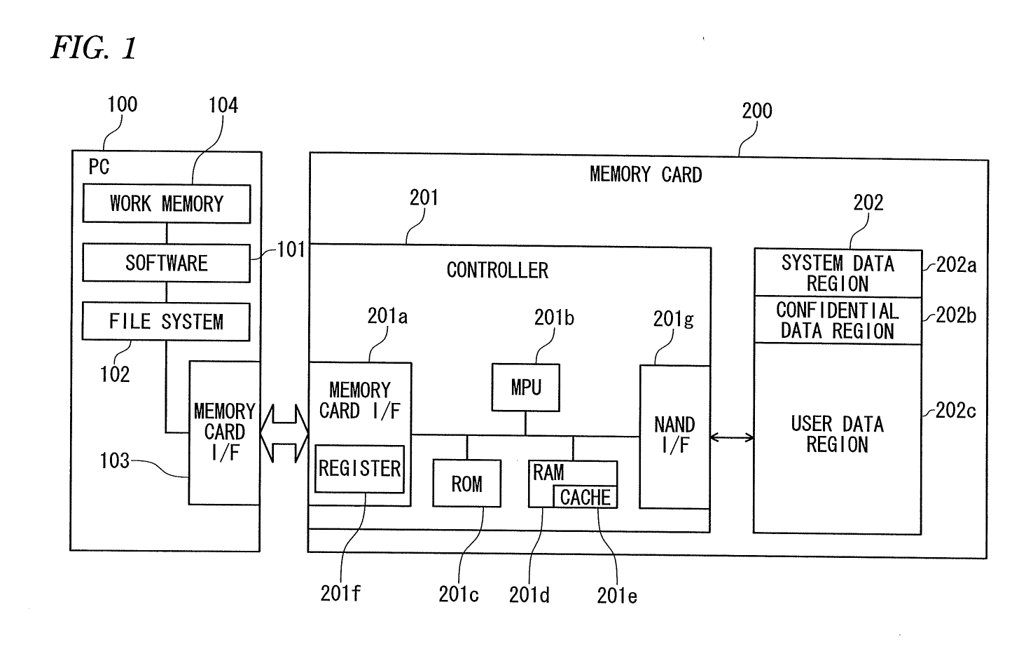

FIG. 1 illustrates a main part of a PC 100 in this embodiment and a main part of a memory card 200 to be managed by the PC 100, as functional blocks respectively. Each of the functional blocks can be achieved by either of hardware and computer software or by combination of both hardware and computer software. Therefore, each block will be generally described in terms of functions so that whether the block is achieved by hardware or by software can be clarified.

Whether such a function is executed as hardware or as software depends on a design constraint imposed on a specific embodiment or the whole system. Although those skilled in the art may achieve these functions by various methods in accordance with each specific embodiment, decision of such achievement belongs to the category of the invention.

As shown in FIG. 1, the PC 100 has hardware and software (system) for accessing the memory card 200 inserted in the PC 100 and connected to the PC 100. First, the PC 100 has software 101 such as applications, an operating system, etc.

When an instruction to execute a process such as writing of data into the memory card 200 or reading of data from the memory card 200 is given based on a user operation, the software 101 controls a CPU (Central Processing Unit) to execute the process. After execution of the software 101, the CPU instructs the memory card 200 to write data or read data through a file system 102.

The file system 102 is a mechanism for managing files recorded on an information recording medium (the memory card 200) which is a target to be managed. The file system 102 manages files based on management information which is recorded in a recording region of the information recording medium.

That is, a method of creating directory information for files, folders, etc. in the information recording medium, a method of moving or deleting files, folders, etc., a data recording method, a place where management information is recorded, a method of using the management information, etc. are defined in the file system 102. The file system 102 is based on an FAT (File Allocation Table) file system. In this embodiment, the file system 102 is configured to be able to execute an operation which will be described below. A specific operation will be described in due order.

The PC 100 further has a memory card interface 103. The memory card interface 103 is constituted by hardware, software etc. necessary for performing interface processing between the PC 100 and a controller 201 of the memory card 200. The PC 100 executes communication with the memory card 200 through the memory card interface 103.

In this case, the memory card interface 103 provides various kinds of agreements necessary for communication between the PC 100 and the memory card 200. That is, the memory card interface 103 has various kinds of command sets by which the memory card interface 103 and a memory card interface 201a (which will be described later) constituting the controller 201 of the memory card 200 can recognize each other. The memory card interface 103 includes hardware configuration (the arrangement of pins, the number of pins, etc.) by which the memory card interface 103 can be connected to the memory card interface 201a of the memory card 200.

The PC 100 further has a work memory 104. The work memory 104 is a temporary storage region such as an RAM (Random Access Memory) which is used as a work area while the PC 100 executes information processing. When data are read from the memory card 200, the PC 100 stores the data read from the memory card 200 into the work memory 104. When data are to be written into the memory card 200, the PC 100 outputs the data to be written (writing-subject data) from the work memory 104 to the memory card 200 and executes write processing.

When the memory card 200 is connected to the PC 100 powered on, or when the PC 100 is powered on after the memory card 200 is connected to the PC 100 powered off, the memory card 200 is initialized in response to power supply from the PC 100 and then executes a process corresponding to access from the PC 100.

The memory card 200 has a memory 202 such as an NAND flash memory, and the controller 201 for controlling the memory 202. Of them, the memory 202 records data nonvolatilely and executes writing or reading of data in accordance with each unit called page composed of plural memory cells. Physical addresses unique to pages respectively are allocated to the pages. The memory 202 executes deletion of data in accordance with each unit called physical block composed of plural pages. Incidentally, physical addresses may be allocated to physical blocks respectively.

The controller 201 manages a data recording state of the memory 202. Management of the recording state means management of correspondence indicating which page (or physical block) indicated by a physical address holds data in a logical address allocated by the PC 100, which page (or physical block) indicated by a physical address is in a deleted state (a state where no data is written or a state where invalid data is held), etc.

In this case, the controller 201 has the memory card interface 201a, an MPU (Micro Processing Unit) 201b, an ROM (Read Only Memory) 201c, an RAM (Random Access Memory) 201d, an NAND interface 201g, etc.

Of these, the memory card interface 201a is constituted by hardware, software etc. necessary for performing interface processing between the PC 100 and the controller 201. The memory card 200 executes communication with the PC 100 through the memory card interface 201a.

The memory card interface 201a provides agreements for enabling communication between the memory card 200 and the PC 100 in the same manner as the memory card interface 103 of the PC 100. The memory card interface 201a has various kinds of command sets and includes hardware configuration (the arrangement of pins, the number of pins, etc.) like the memory card interface 103 of the PC 100. The memory card interface 201a further has a register 201f.

The MPU 201b generally controls the operation of the memory card 200 as a whole. That is, when, for example, the memory card 200 is supplied with electric power, the MPU 201b reads a firmware (control program) stored in the ROM 201c onto the RAM 201d and executes processing.

The MPU 201b creates various kinds of tables (which will be described later) on the RAM 201d based on the control program or executes a predetermined process on the memory 202 in response to a write command, a read command, a delete command, etc. from the PC 100.

Further, the ROM 201c stores the control program, etc. to be executed by the MPU 201b, as described above.

In addition, the RAM 201d provides a work area to the MPU 201b. The control program and various kinds of tables are recorded on the RAM 201d. One of the tables is a conversion table (logical-physical table) indicating correspondence between a logical address allocated to data by the file system 102 of the PC 100 and a physical address of a page on which data having the logical address is actually recorded.

Further, when the PC 100 is to write/read data into/from the memory 202, a part of the RAM 201d is used as a cache 201e which is a temporary storage region. When, for example, the PC 100 is to write data into the memory 202, the controller 201 once stores data to be written in the cache 201e of the RAM 201d and then writes the data stored in the cache region into the memory 202. When, for example, the PC 100 is to read data from the memory 202, the controller 201 once stores data to be read in the cache region of the RAM 201d and then transmits the data stored in the cache 201e to the PC 100.

The cache 201e has a capacity of 4 MB (megabytes) reserved in the RAM 201d. Because the capacity of the cache 201e is the maximum data quantity allowing the controller 201 to write/read data into/from the memory 202 at once, the controller 201 in this embodiment can execute the process of writing/reading a maximum of 4 MB data into/from the memory 202 at once.

In this embodiment, the cache 201e which is a predetermined region in the RAM 201d is taken as an example of the temporary storage region used for execution of data writing/reading. However, the invention is not limited thereto. The cache for data writing/reading may be provided so as to be separate from the RAM 201d.

The NAND interface 201g performs interface processing between the controller 201 and the memory 202.

The recording region in the memory 202 is partitioned into regions in accordance with kinds of data to be stored.

The regions include a system data region 202a, a confidential data region 202b, and a user data region 202c.

Of these, the system data region 202a is a region reserved in the memory 202 for storing data necessary for the operation of the controller 201. That is, the system data region 202a stores management information mainly concerned with the memory card 200, and stores security information of the memory card 200 and card information of media ID (identification), etc.

The confidential data region 202b is a region for storing key information used for encryption, confidential data used for authentication, etc. The confidential data region 202b is prevented from being accessed by the PC 100.

Further, the user data region 202c is a region allowed to be freely accessed and used by the PC 100. User data such as AV (Audio Visual) contents files, video data, etc. are stored in the user data region 202c. In the following description, the recording region of the memory 202 means the user data region 202c.

Incidentally, the controller 201 reserves a part of the user data region 202c for storing control data (logical-physical table) necessary for the operation of the controller 201. The user data region 202c is logically formatted as a separate volume from the PC 100 and subjected to file management.

The logical format of the memory 202 will be described next. The memory 202 is logically formatted in the following form. Logical formatting of the memory 202 is performed by the file system 102 in the PC 100.

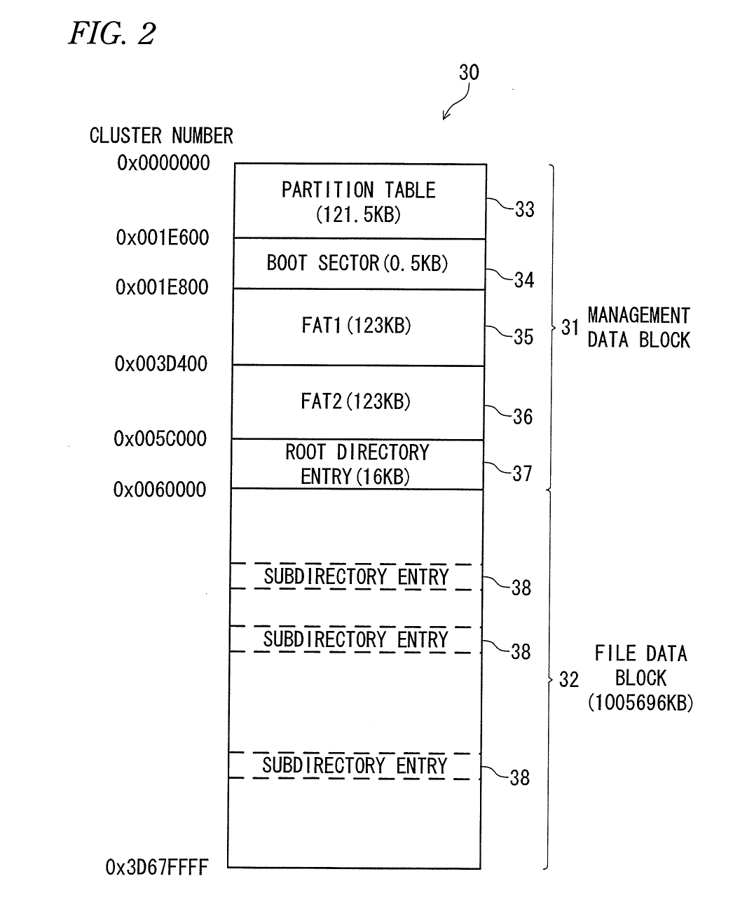

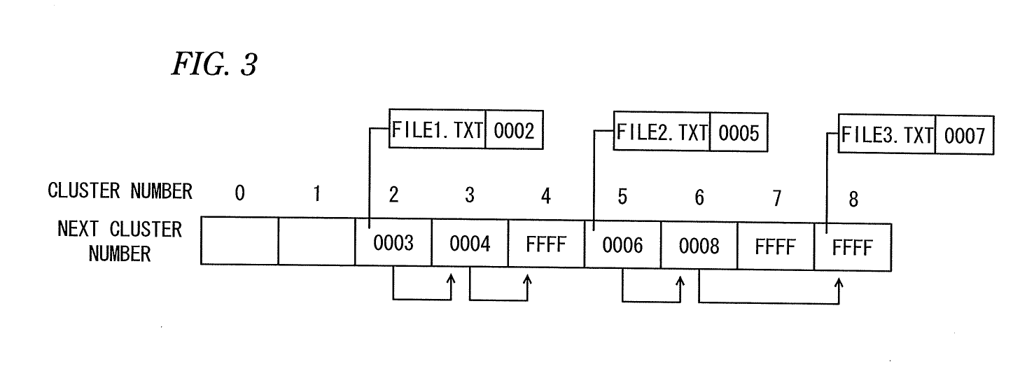

Prior to description of logical formatting of the memory 201 performed by the file system 102, an FAT file system as the basis of the file system 102 will be described in brief with reference to FIGS. 2 and 3.

FIG. 2 shows a memory space 30 of the memory 202 logically formatted by an FAT file system. The following management data are written in the memory space 30. Incidentally, the memory space 30 mentioned herein is a memory region which can be accessed freely by the FAT file system and which corresponds to the user data region 202c in the memory 202 shown in FIG. 1.

As shown in FIG. 2, the FAT file system manages the memory space 30 to be managed while the memory space 30 is split into clusters each having a′predetermined size (e.g. 16 kbytes). Management data are allocated to a region ranging from the least significant cluster number to a predetermined cluster number in the memory space 30. The region where management data are recorded is hereinafter referred to as management data block 31.

Incidentally, a region indicated by higher significant cluster numbers than the management data block 31 serves as a data recording region for writing plural file data constituting a file. The data recording region is hereinafter referred to as file data block 32.

The management data block 31 is separated into a partition table region 33 allocated as a partition table, a boot sector region 34 allocated as a boot sector, an FAT1 region 35 allocated as FAT1, an FAT2 region 36 allocated as FAT2, and a root directory entry region 37 allocated as a root directory entry.

Of these, the partition table region 33 stores information about the file system type, leading sector, etc. of each partition. The boot sector region 34 is located in a leading sector indicated by the partition table and stores a BPB [BIOS (Basic Input/Output System) Parameter Block].

The BPB indicates various parameters of the memory 202 used by the file system. In the FAT file system, the parameters are written when the memory 202 is logically formatted. The FAT file system reads the BPB at startup to thereby recognize the parameters of the file format.

The FAT1 region 35 stores information indicating the cluster where a part of file data written in the memory and split by the cluster size (hereinafter simply referred to as file data) is recorded, and information indicating association of clusters for restoring the file data. The FAT2 region 36 is an FAT1 backup region where the same contents as those of the FAT1 region 35 are stored.

Because it is preferable that respective file data constituting one file are allocated to continuous clusters, the FAT file system is configured so that free clusters are allocated for file data in order of cluster number. FAT1 and FAT2 store information indicating connection relations of clusters where the file data are stored. Accordingly, data are read from clusters based on the information stored in FAT1 and FAT2 (hereinafter simply referred to as FAT) to thereby restore the original file.

The root directory entry region 37 records file entries of respective files belonging to a root directory. Each file entry includes file name or folder name, file size, attribute, file update date and time information, a flag indicating a cluster as the leading cluster of the file, etc. According to the version [e.g. FAT16, FAT32, ex (extended) FAT, etc.] of the FAT format specification, the root directory entry can be located in any address after FAT.

When a certain file belongs to a subdirectory belonging to the root directory, the number of a cluster allocated to an entry of the subdirectory (subdirectory entry) belonging to the root directory is written in the root directory entry region 37.

The subdirectory entry holds file entries of respective files belonging to the subdirectory. As shown in FIG. 2, the subdirectory entry is written in any cluster 38 in the file data block 32 by the FAT file system. The subdirectory entry belongs to management data and is often rewritten frequently.

FIG. 3 shows an example of FAT and file entries. As shown in FIG. 3, the root directory entry stores information of positions of leading clusters of respective files “FILE1.TXT”, “FILE2.TXT” and “FILE3.TXT” as file entries. The leading clusters of the files “FILE1.TXT”, “FILE2.TXT” and “FILE3.TXT” have 0002, 0005 and 0007 as their cluster numbers respectively.

The numbers of next clusters to be connected to the respective clusters are written in FAT. For example, in the case of “FILE1.TXT”, it is known that a cluster where data following the data of the leading cluster (cluster number 0002) are stored has 0003 as its cluster number, and that a cluster where data following the data of the cluster (cluster number 0003) are stored has 0004 as its cluster number.

Data of respective clusters (cluster numbers 0002, 0003 and 0004) are connected successively to thereby restore the file “FILE1.TXT”. Incidentally, “FFFF” is written in a cluster where the last part of the file data are stored.

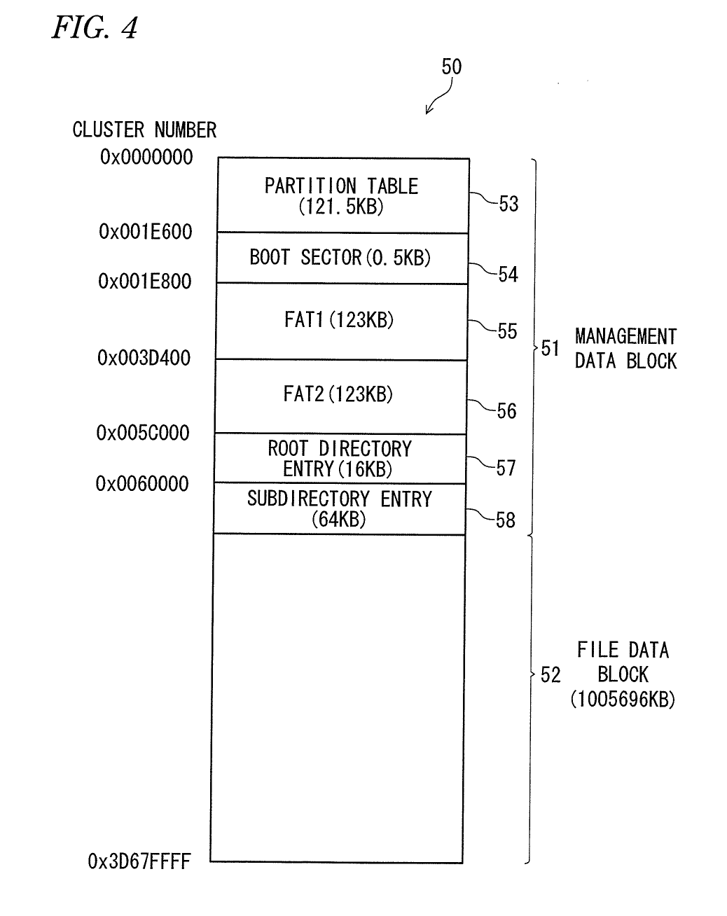

The file system 102 based on the FAT file system will be described next with reference to FIG. 4. In the file system 102, the memory 202 is logically formatted as follows. That is, the memory 202 is logically formatted by the file system 102.

FIG. 4 shows a memory space 50 of the memory 202 logically formatted by the file system 102. The memory space 50 shown in FIG. 4 corresponds to the user data region 202c which is included in the recording region of the memory 202 to be formatted and which can be used by the file system 102.

As shown in FIG. 4, the file system 102 is configured so that a recording region for allocating management data used for managing file data is limited to a region ranging from the least significant cluster number (or logical address) to a predetermined cluster number (or logical address) in the user data region 202c. That is, management data are allocated to a recording region of cluster numbers (or logical addresses) in the predetermined range and recorded in the recording region.

The management data includes a partition table, a boot sector, an FAT1, an FAT2, a root directory entry and a subdirectory entry in the same manner as used in the FAT file system.

A block where management data are stored (management data block 51) includes a partition table region 53 allocated as a partition table, a boot sector region 54 allocated as a boot sector, an FAT1 region 55 allocated as FAT1, an FAT2 region 56 allocated as FAT2, a root directory entry region 57 allocated as a root directory entry, and a subdirectory entry region 58 allocated as a subdirectory entry. Data stored in the partition table region 53 to the subdirectory entry region 58 are the same as defined in the FAT file system.

The other part of the memory space 50 than the management data block 51 is a file data block 52 used exclusively for writing file data. The capacity of the management data block 51 is determined in consideration of the size of the memory space 50 and the size of the file data block 52 which needs to be reserved.

For example, the capacity of the partition table region 53 is 121.5 kbytes, the capacity of the boot sector region 54 is 0.5 kbytes, the capacity of the FAT1 region 55 is 123 kbytes, the capacity of the FAT2 region 56 is 123 kbytes, the capacity of the root directory entry region 57 is 16 kbytes, and the capacity of the subdirectory entry region 58 is 64 kbytes.

Incidentally, the file system 102 is based on the FAT file system (regardless of the difference between FAT16, FAT32, exFAT or the like). Besides the FAT file system, a similar file system including extension of FAT can be used. For example, the similar file system is a file system in which management data are used for managing file data and frequently rewritten.

The memory card 200 is logically formatted by the file system 102. Accordingly, the memory 202 is logically formatted as shown in FIG. 4.

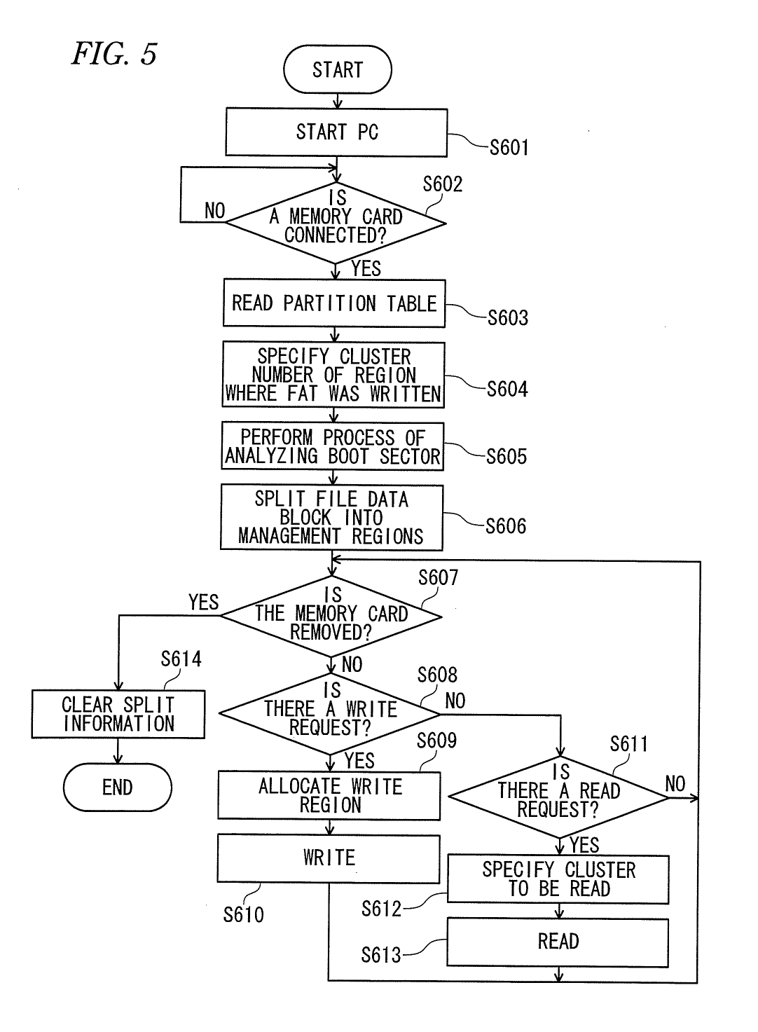

A process of writing/reading data into/from the memory 202 logically formatted as shown in FIG. 4 will be described next with reference to FIG. 5.

First, when the PC 100 is started up (step S601), the file system 102 comes into a waiting state to wait for the memory card 200 to be connected to the memory card interface 103 (step S602: No).

When the memory card 200 is then connected to the memory card interface 103 (step S602: Yes), the file system 102 accesses the user data region 202c of the memory 202 and executes reading of the partition table from the partition table region 53 in the user data region 202c (step S603).

Then, the file system 102 specifies the cluster numbers (or logical addresses) of the FAT1 region 55 and the FAT2 region 56 where FAT1 and FAT2 are written, in the regions of the user data region 202c from the read partition table (step S604) and executes an analysis process of the boot sector region 54 located in the leading sector indicated by the read partition table (step S605).

Specifically, the file system 102 executes an analysis process of the boot sector region 54 to thereby execute reading of the BPB indicating various parameters of the memory 202 such as the cluster number and size of the file data block 52, and the cluster numbers and sizes of the root directory entry region 57 and the subdirectory entry region 58 where the root directory and subdirectory are written, in the regions of the user data region 202c.

Further, the file system 102 splits the file data block 52 into management regions as indicated by the cluster numbers and sizes read by the analysis process of the boot sector region 54, and records the cluster number of the least significant (or most significant) cluster in each of the management regions as split information (step S606).

The file system 102 splits the file data block 52 into management regions 1 to 4 each having a size divisible by a size (e.g. 512 kbytes) allowing increase in file data writing speed, but holds the other regions as miscellaneous regions.

Then, the file system 102 monitors whether the memory card 200 is detached from the memory card interface 103 or not (step S607), and comes into a waiting state to wait for a file data write request and a file data read request from the software (application) 101 (steps S608 and S611).

When there is a file data write request from the software 101 (step S608: Yes) while the memory card 200 is not detached from the memory card interface 103 (step S607: No), the file system 102 allocates a cluster for writing the file data as a subject of the write request, and outputs the logical addresses of logical blocks collected into the allocated cluster and the file data as a subject of the write request, to the controller 201 (step S609).

Upon reception of the file data outputted from the file system 102, the controller 201 temporarily stores the file data into the cache 201e in the RAM 201d and writes the file data into the memory 202 (step S610).

When there is no file data write request from the software 101 in step S608 (step S608: No) but there is a file data read request (step S611: Yes), the file system 102 specifies a logical address where the file data as a subject of the read request are written (step S612), and outputs the file data read request to the controller 201.

Upon reception of the file data read request from the file system 102, the controller 201 reads the file data from the memory 202 to the cache 201e, and outputs the data read to the cache 201e to the PC 100 (step S613).

When the step S610 is completed, when there is no read request in the step S611 (step S611: No) or when the step S613 is completed, processing goes back to the step S607.

When the determination in the step S607 results in that the memory card 200 is detached from the memory card interface 103 (step S607: Yes), the file system 102 clears recorded split information (step S614) and a series of processes is terminated.

The file system 102 controls a process of writing/reading data into/from the memory 202 of the memory card 200. The process of writing/reading data into/from the memory 202 will be described more in detail.

As described above, the quantity of data allowed to be written/read into/from the memory 200 at once depends on the capacity of the cache 201e. The controller 201 manages the memory 202 from the top address in accordance with the size of the cache. That is, when writing/reading of data is executed in this embodiment, the top address subjected to writing/reading by the controller 201 is an address corresponding to an integral multiple of 4 M (Mega). When data stored in the memory 202 lies across the address corresponding to an integral multiple of 4 M, the controller 201 executes data reading any plural number of times.

That is, the possibility that data written from an address corresponding to an integral multiple of 4 M from the top address of the memory 202 will lie over an address just before the integral multiple of 4 M and the address of the integral multiple of 4 M becomes lowest. The frequency of data which will lie over an address just before the integral multiple of 4 M and the address of the integral multiple of 4 M is minimized regardless of the size of the data. Accordingly, data written from an address of an integral multiple of 4 M is lowest in terms of the number of times of read, compared with data written from a different address. In the following description, writing data into an address corresponding to an integral multiple of 4 M from the top address of the memory 202 is referred to as “writing aligned data”, and the written data is referred to as “aligned data”. In addition, the address corresponding to an integral multiple of 4 M from the top address of the memory 202 is referred to as “data alignable address”.

When data lies over a data alignable address of the memory 202 and an address just before the data alignable address, the write/read processing speed is reduced. When this is repeated, deterioration of performance occurs. This reason will be described below.

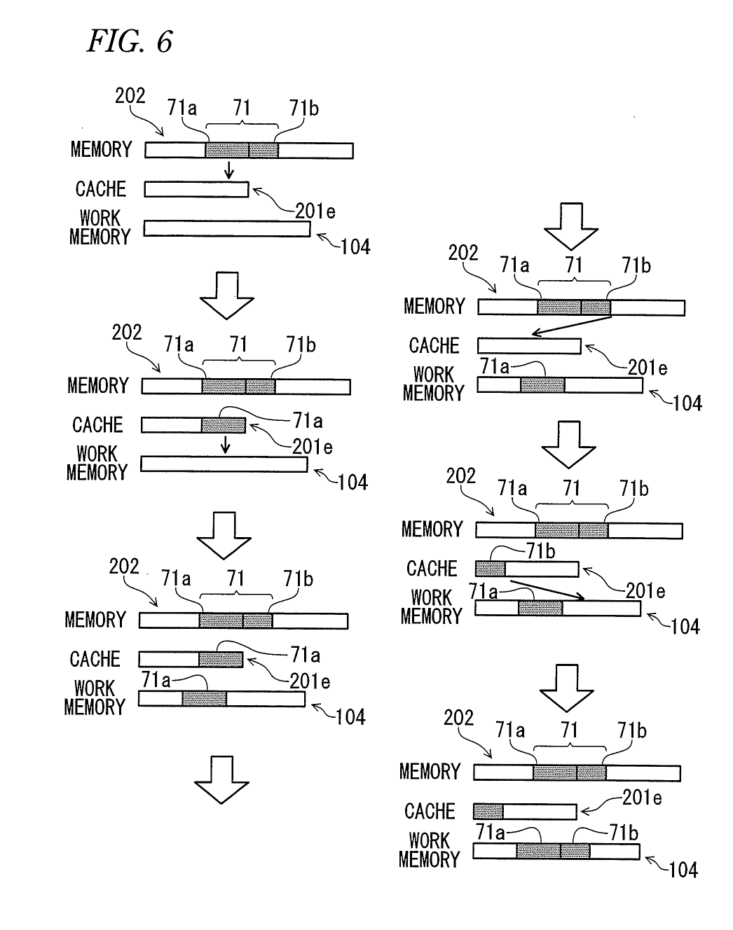

FIG. 6 illustrates a reading process for reading unaligned data in this embodiment. FIG. 6 conceptually shows a flow of the reading process for reading unaligned data 71 stored in the memory 202 and lying over a data alignable address and an address just before the data alignable address.

The data 71 has data 71a which is the first half data, and data 71b which is the second half data. The data 71a is stored in addresses before the data alignable address. The data 71b is stored in addresses on and after the data alignable address.

When the file system 102 reads the data 71, the controller 201 does not read the data 71 at once as described above. That is, the controller 201 first reads the data 71a located before the data alignable address and stores the data 71a in the cache 201e.

Then, the controller 201 outputs the data 71a stored in the cache 201e to the PC 100. Upon reception of the output of the data 71a from the controller 201, the file system 102 stores the data 71a in the work memory 104.

Then, the controller 201 reads the data 71b located on and after the data alignable address and stores the data 71b in the cache 201e. The controller 201 outputs the data 71b stored in the cache 201e to the PC 100. The file system 102 stores the data 71b in the work memory 104 so that the data 71a and 71b become continuous to each other.

By the aforementioned processing, the file system 102 can read the data 71 from the memory 202 and store the data 71 in the work memory 104.

When data lies over a data alignable address and an address just before the data alignable address while the data is read from the memory 202, the process of reading data from the memory 202 is performed twice as described above because the controller 201 cannot read the data at once.

A reading process for reading aligned data 81 stored in the memory 202 so as not to lie over a data alignable address and an address just before the data alignable address will be described next.

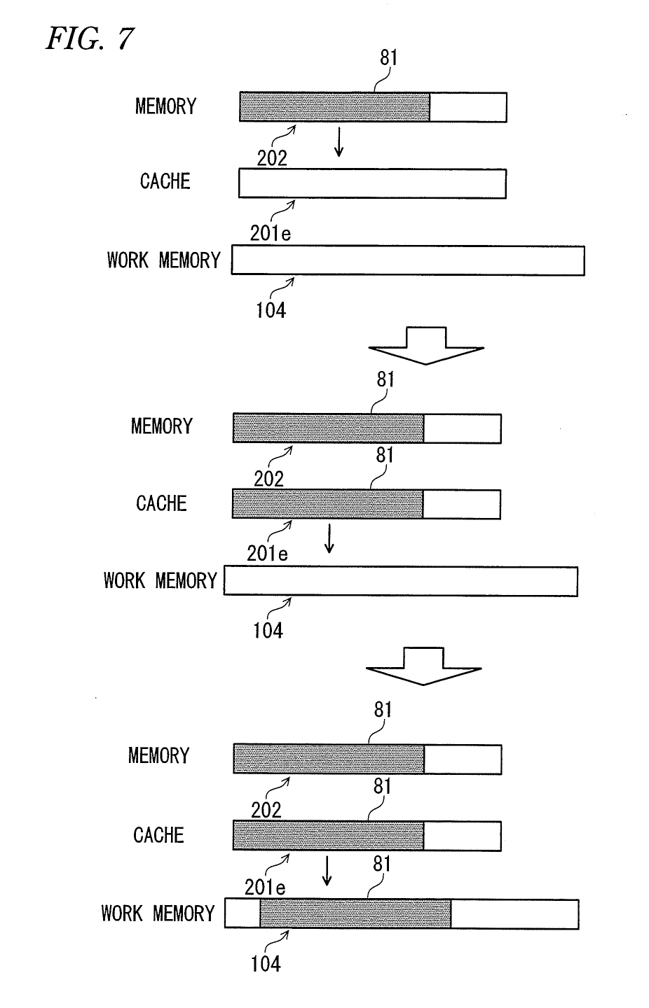

FIG. 7 illustrates the reading process for reading aligned data in this embodiment.

The data 81 is aligned data which has such a size that the data does not lie over a next data alignable address and an address just before the data alignable address.

When the file system 102 is to read the data 81, the controller 201 reads the data 81 based on a request given from the file system 102. On this occasion, the controller 201 can read the data 81 at once because the data 81 does not lie over a data alignable address and an address just before the data alignable address. The controller 201 stores the read data 81 in the cache 201e at once.

Then, the controller 201 outputs the data 81 to the PC 100. Upon reception of the output of the data 81 from the controller 201, the file system 102 stores the data 81 in the work memory 104.

By the aforementioned processing, the file system 102 can read the data 81 from the memory 202 and store the data 81 in the work memory 104. As described above, when data to be read does not lie over a data alignable address and an address just before the data alignable address, the controller 201 can read the data at once. That is, a reading process for reading data which does not lie over a data alignable address and an address just before the data alignable address is reduced compared with that for reading data which lies over a data alignable address and an address just before the data alignable address, so that the file system 102 can read the data at a high speed from the memory 202.

A data writing process will be described next.

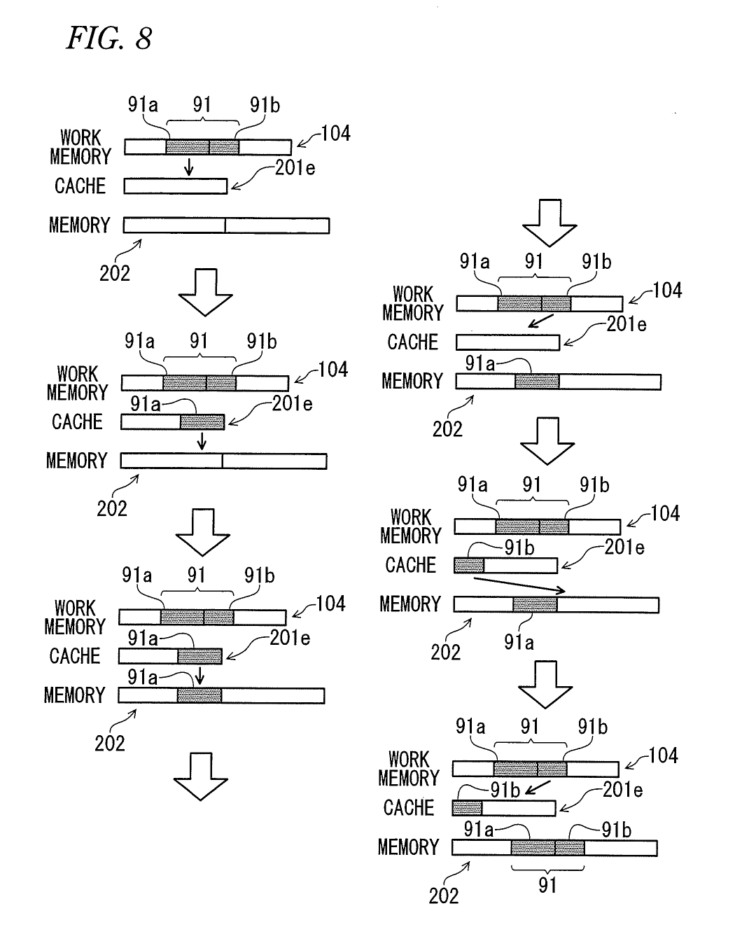

FIG. 8 illustrates the writing process for writing unaligned data into the memory 202 in this embodiment. FIG. 8 conceptually shows a flow of the writing process for writing unaligned data 91 in the memory 202 so that the data 91 lies over a data alignable address and an address just before the data alignable address.

When the data 91 is to be written in the memory 202 so that the data 91 lies over a data alignable address and an address just before the data alignable address, the file system 102 splits the data 91 of the work memory 104 into data 91a and 91b and outputs the split data 91a and 91b to the controller 201.

Upon reception of a request from the file system 102 to write data into the memory 202, the controller 201 reads data corresponding to a write target region of the memory 202 to the cache 201e. On this occasion, the controller 201 reads data at twice because a boundary between a data alignable address and an address just before the data alignable address is present in the write target region of the memory 202.

Then, the data read to the cache 201e is updated to the data 91a and 91b outputted from the file system 102, so that the updated data 91a and 91b are written into the memory 202.

By the aforementioned processing, data on the work memory 104 can be written into the memory 202. As described above, when data is to be written so that the data lies over a data alignable address and an address just before the data alignable address, the controller 201 needs to perform the process of reading/writing data from/into the memory 202 twice respectively because the data cannot be read/written at once.

A data writing process for writing aligned data 1001 into the memory 202 in this embodiment will be described next.

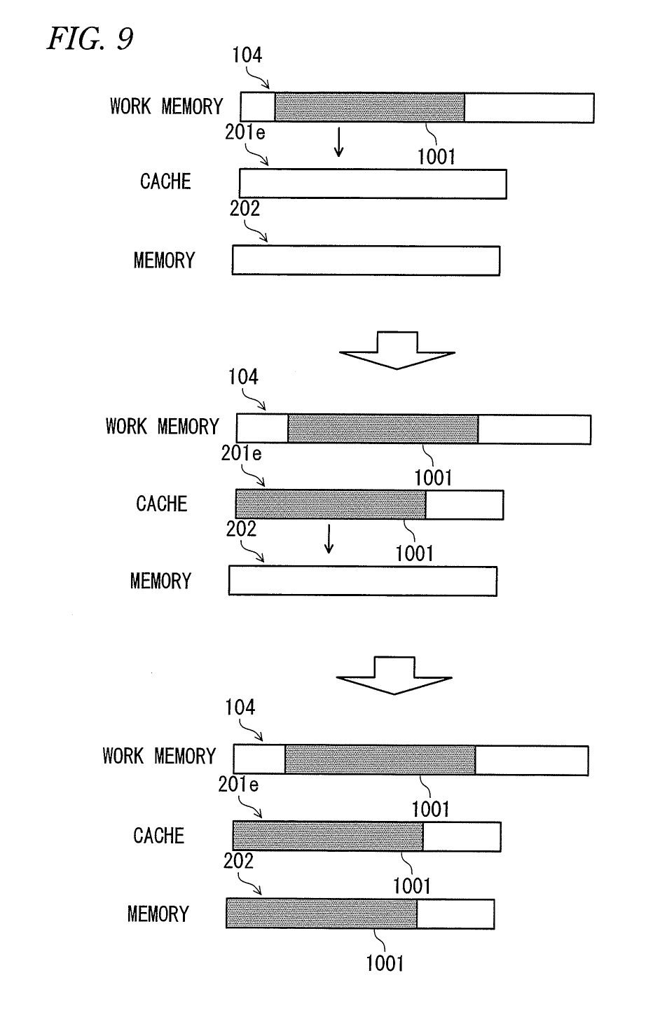

FIG. 9 illustrates a writing process for writing aligned data in this embodiment.

On this occasion, the file system 102 writes data 1001 on the work memory 104 into the memory 202 in a predetermined address (data alignable address) corresponding to an integral multiple of 4 M from the top address of the memory 202. For the sake of simplification, assume that the data 1001 does not have a length from the data alignable address to a next address corresponding to an integral multiple of 4 M from the top address.

First, the file system 102 outputs a data write request and write destination address information to the controller 201. Upon reception of the data write request, the controller 201 reads data from the write target address (predetermined address corresponding to an integral multiple of 4 M from the top address) of the memory 202 into the cache 201e.

Then, the file system 102 outputs the data 1001 of the work memory 104 to the controller 201. Upon reception of the output of the data 1001, the controller 201 updates the output data 1001 of the file system 102 to the data read into the cache 201e, and writes the updated data into a predetermined address corresponding to an integral multiple of 4 M on the memory 202.

By the aforementioned processing, the file system 102 can write aligned data into the memory 202. As described above, when data is to be written so that the data does not lie over a data alignable address and an address just before the data alignable address, the controller 201 can perform the reading/writing process at once.

That is, when aligned data is to be written into the memory 202, the data writing process can be executed in the assumable shortest time because the number of times by which the data lies across a byte boundary is minimized. In addition, when aligned data is to be read from the memory 202, the data reading process can be executed in the assumable shortest time because the number of times of read is minimized compared with the other case.

A data writing process in this embodiment will be described in consideration of the above description.

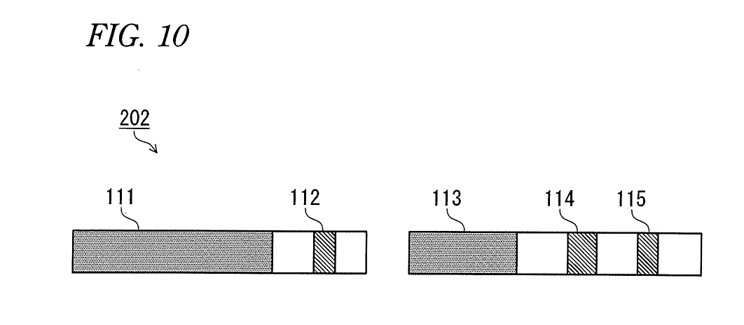

FIG. 10 illustrates a state in the memory 202 subjected to the data writing process in this embodiment. FIG. 10 conceptually shows a state where data 111 to 115 are written (stored) in the memory 202.

The data 111 and 113 are first data (with high extensibility) having a high possibility that the data size will be extended. The data 112, 114 and 115 are second data (with low extensibility) having a low possibility that the data size will be extended.

The “first data (with high extensibility) having a high possibility that the data size will be extended” means substantial data such as file content information. The “second data (with low extensibility) having a low possibility that the data size will be extended” means meta data such as file directory information.

In this embodiment, when data are to be written into the memory 202, first data (with high extensibility) having a high possibility that the data size will be extended are written preferentially so as to be aligned. On the other hand, second data (with low extensibility) having a low possibility that the data size will be extended are written so as not to be aligned, so that an address (data alignable address) corresponding to an integral multiple of 4 M from the top address is retained for the first data.

In this manner, the speed of the process of writing/reading data (high extensible data: first data) large in data size important in performance is improved so that the memory 202 comes into an ideal recording state.

A flow of the characteristic writing process in this embodiment will be described next.

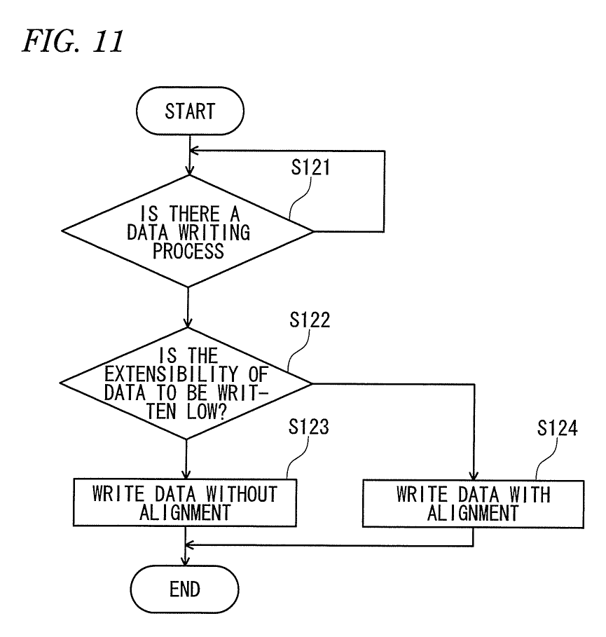

FIG. 11 illustrates the characteristic writing process in this embodiment.

First, the file system 102 waits for a write instruction from the software 101 (step S121: No).

Upon reception of the data write instruction from the software 101 (step S121: Yes), the file system 102 serves as a discrimination module which determines whether or not data to be written is second data (with low extensibility) having a low possibility that the data size will be extended (step S122).

When the file system 102 determines that data to be written is second data (with low extensibility) having a low possibility that the data size will be extended (step S122: Yes), the file system 102 serves as an allocation module to write the data into the memory 202 without allocating an alignable address to the data (i.e. without aligning the data) (step S123). That is, the file system 102 writes the data while an address corresponding to an integral multiple of 4 M from the top address of the memory 202 is not used as the top.

When the determination in the step S122 results in that data to be written is not second data (with low extensibility) having a low possibility that the data size will be extended (step S122: Yes), the file system determines that the data is first data, and serves as an allocation module to write the data into the memory 202 while allocating an alignable address to the data (i.e. aligning the data) (step S124). That is, the file system writes the data while an address corresponding to an integral multiple of 4 M from the top address of the memory 202 is used as the top.

After completion of the steps S123 and S124, a series of processing flow is terminated.

In this embodiment, because first data (with high extensibility) having a high possibility that the data size will be extended is aligned and written preferentially in the memory 202 of the memory card 200 (an alignable address is allocated to the data), the effect of having a high data reading speed can be kept even after the memory card 200 is attached or detached. The same thing can apply to the case where data in the memory card 200 is read from another device than the PC 100.

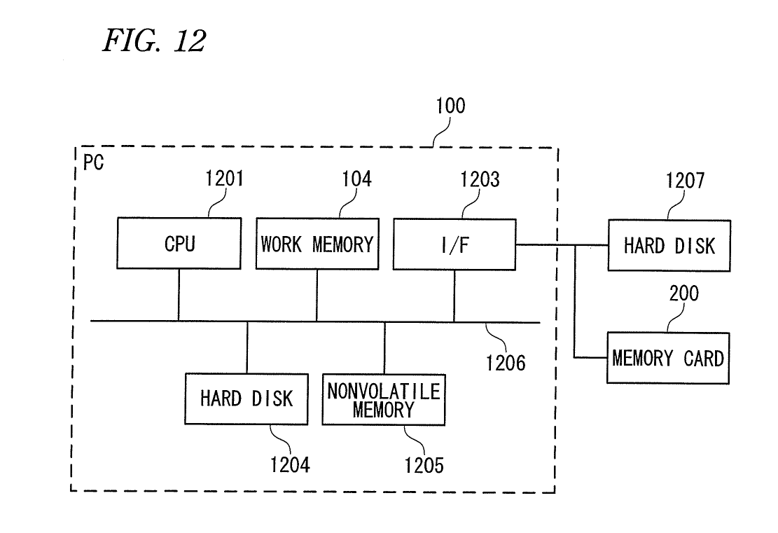

FIG. 12 illustrates the PC in this embodiment. The PC 100 has a CPU 1201 which controls respective portions in a concentrated manner. A nonvolatile memory 1205 such as an ROM which is a read only memory for recording a BIOS or the like and a work memory 104 such as an RAM for rewritably recording various types of data are connected to the CPU 1201 by a bus 1206.

A hard disk 1204 for storing various types of programs such as a recording region allocating program and an I/F 1203 having a USB (universal serial bus) connector for connecting an external hard disk 1207 to the PC 100, a memory card interface 103 for inserting the memory card 200 such as an SD card etc. are connected to the bus 1206 through an I/O not shown.

An OS (operating system) and various types of programs are recorded on the nonvolatile memory 1205. The CPU 1201 reads programs recorded on the nonvolatile memory 1205, and installs the programs in the hard disk 1204.

Besides the memory card 200, various types of media such as various types of optical disks (e.g. DVD (digital versatile disk)), various types of opto-magnetic disks, various types of magnetic disks (e.g. flexible disk), semiconductor memory, etc. can be used as information recording media for recording files.

Alternatively, programs downloaded from a network such as Internet through a communication controller not shown may be installed in the hard disk 1204. In this case, this invention can be applied also to a recording device which records programs on a transmission-side server.

Incidentally, the programs may operate on a predetermined OS. In this case, a part of various processes may be taken over by the OS or may be contained as a part of a group of program files constituting predetermined application software, an OS, etc.

The CPU 1201 which controls the operation of this system as a whole executes various types of processes based on programs loaded on the hard disk 1204 used as a main recording device of this system.

The programs executed by the PC 100 are formed as modules containing the respective portions (the software 101, the file system 102 and the memory card interface 103). As for actual hardware, the CPU 1201 (processor) reads programs from the aforementioned recording medium and executes the programs to thereby load the respective portions on the main recording device and generate the software 101, the file system 102 and the memory card interface 103 on the main recording device.

When data is to be written into the memory card 200, the PC 100 in this embodiment determines extensibility of the data and determines based on the extensibility whether the data is written with alignment or without alignment. Accordingly, regions in the memory 202 can be used effectively so that the speed of the process of writing/reading high extensible data can be improved. In other words, a data alignable precious address can be allocated to high extensible data preferentially so that regions in the memory 202 can be used effectively. In this manner, the number of times in writing/reading data on the whole of the memory 202 can be also reduced to thereby contribute to extension of the life of the memory card 200.

Incidentally, the invention is not limited to the aforementioned embodiment per se at all and constituent members may be modified to embody the invention without departing from the gist of the invention in a practical stage. Constituent members disclosed in the embodiment may be combined suitably to form various inventions. For example, some of all constituent members disclosed in an embodiment may be removed. Constituent members in different embodiments may be combined suitably.

1. An information processing apparatus, comprising:
a discrimination module configured to determine whether writing-subject data to be written into a storage region of an information recording medium is high extensible data or low extensible data; and
an allocation module configured to allocate a data alignable address in the storage region as an address for writing the data preferentially when the writing-subject data is the high extensible data rather than when the writing-subject data is the low extensible data.

2. The apparatus of claim 1,
wherein the discrimination module determines that the writing-subject data is low extensible data when the writing-subject data is directory information in an FAT file system.

3. The apparatus of claim 1,
wherein the discrimination module determines that the writing-subject data is high extensible data when the writing-subject data is not low extensible data.

4. The apparatus of claim 1,
wherein the data alignable address in the storage region is an address depending on a size of a cache for a writing process in the storage region.

5. An information processing apparatus, comprising:
a discrimination module configured to determine whether writing-subject data to be written into a storage region of an information recording medium is low extensible data or not; and
an allocation module configured to allocate a data unalignable address in the storage region as a write destination address preferentially when the writing-subject data is the low extensible data.

6. The apparatus of claim 5,
wherein the discrimination module determines that the writing-subject data is low extensible data when the writing-subject data is directory information in an FAT file system.

7. An information processing method, comprising:
determining whether writing-subject data to be written into a storage region of an information recording medium is high extensible data or low extensible data; and
allocating a data alignable address in the storage region as an address for writing the data preferentially when the writing-subject data is the high extensible data rather than when the writing-subject data is the low extensible data.
